(19) United States
(12) Patent Application Publication
(10) Pub. No.: US 2025/0392169 A1
(43) Pub. Date: Dec. 25, 2025

(54) WIRELESSLY RECHARGEABLE POWER SUPPLY DEVICE

(71) Applicant: TOYODA GOSEI CO., LTD., Kiyosu-shi (JP)

(72) Inventors: Tsubasa SUZUKI, Kiyosu-shi (JP); Tomokazu SAKAI, Kiyosu-shi (JP); Yuki TOKUYAMA, Kiyosu-shi (JP); Shinichiro FUKI, Kiyosu-shi (JP)

(21) Appl. No.: 19/227,732

(22) Filed: Jun. 4, 2025

(30) Foreign Application Priority Data
Jun. 25, 2024 (JP) 2024-102259

(51) Int. Cl. H02J 50/27; H01Q 1/24; H02J 50/00; H02J 50/40

(52) U.S. Cl. CPC H02J 50/27; H01Q 1/248; H02J 50/005; H02J 50/402

(57) ABSTRACT

A wirelessly rechargeable power supply device includes a housing, a substrate, a power storage device, and a power receiving antenna. The substrate, the power storage device, and the power receiving antenna are accommodated in the housing. The substrate includes a first main surface and a second main surface opposite to the first main surface. A power receiving circuit is mounted on the substrate. The power receiving antenna includes a first antenna located at a side of the substrate corresponding to the first main surface, and a second antenna located at a side of the substrate corresponding to the second main surface. The first antenna and the second antenna each include a dipole antenna. A direction in which an element of the first antenna extends coincides with a direction in which an element of the second antenna extends.

### CROSS-REFERENCE TO RELATED APPLICATIONS

This application is based upon and claims the benefit of priority from Japanese Patent Application No. 2024-102259, filed on Jun. 25, 2024, the entire contents of which are incorporated herein by reference.

### BACKGROUND

### 1. Field

The following description relates to a wirelessly rechargeable power supply device.

### 2. Description of Related Art

Japanese Patent No. 6725531 describes a wirelessly rechargeable power supply device having the form of a AA battery. The device incorporates one or more antennas that are rotated together with a flexible circuit board, and a spatial controller that automatically rotates the flexible circuit board. In this device, the spatial controller rotates the flexible circuit board for optimal antenna arrangements.

It is desired to expand a power reception range of a wirelessly rechargeable power supply device so as to efficiently charge a power storage device incorporated in the wirelessly rechargeable power supply device.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A wirelessly rechargeable power supply device according to one general aspect of the present disclosure includes a housing, a substrate, a power storage device, and a power receiving antenna. The substrate, the power storage device, and the power receiving antenna are accommodated in the housing. The substrate includes a first main surface and a second main surface opposite to the first main surface. A power receiving circuit configured to charge the power storage device with power received by the power receiving antenna is mounted on the substrate. The power receiving antenna includes a first antenna located at a side of the substrate corresponding to the first main surface, and a second antenna located at a side of the substrate corresponding to the second main surface. The first antenna and the second antenna each include a dipole antenna. A direction in which an element of the first antenna extends coincides with a direction in which an element of the second antenna extends.

Other features and aspects will be apparent from the following detailed description, the drawings, and the claims.

### BRIEF DESCRIPTION OF THE DRAWINGS

FIG. 1 is a block diagram showing the configuration of a wirelessly rechargeable power supply device in accordance with an embodiment.

FIG. 2 is a perspective view of the wirelessly rechargeable power supply device in accordance with the embodiment.

FIG. 3 shows side views and a cross-sectional view of the wirelessly rechargeable power supply device in accordance with the embodiment.

FIG. 4 is an exploded perspective view of the wirelessly rechargeable power supply device in accordance with the embodiment.

FIG. 5 is a plan view showing the internal structure of the wirelessly rechargeable power supply device in accordance with the embodiment.

FIG. 6 is a perspective view showing the arrangement of a substrate and antennas of the wirelessly rechargeable power supply device in accordance with the embodiment.

FIG. 7 is a cross-sectional view taken along line 7-7 shown in FIG. 6.

FIG. 8 is a plan view showing a power receiving antenna in accordance with the embodiment.

FIG. 9 shows a simulation result indicating an emission pattern of the wirelessly rechargeable power supply device in accordance with the embodiment.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

An embodiment of the present disclosure will now be described.

### Circuitry of Wirelessly Rechargeable Power Supply Device

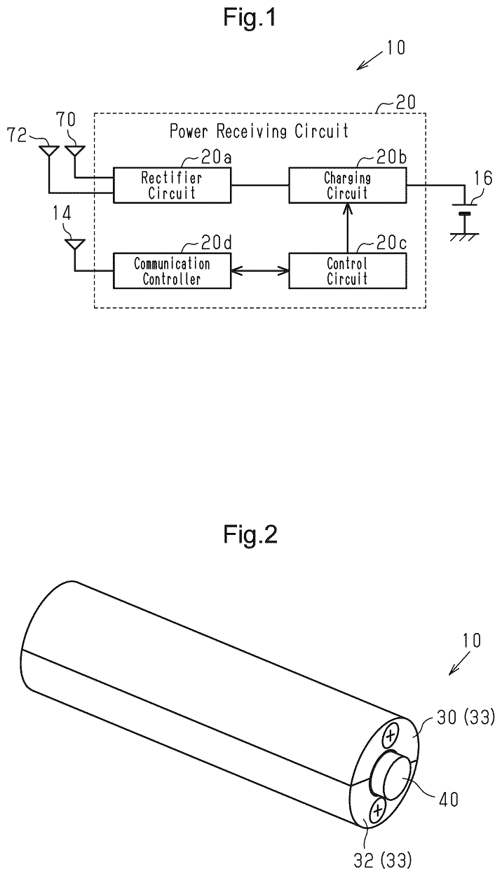

FIG. 1 shows circuitry of a wirelessly rechargeable power supply device 10 in accordance with the present embodiment. The wirelessly rechargeable power supply device 10 includes a pair of power receiving antennas, namely, a first antenna 70 and a second antenna 72, a communication antenna 14, a power storage device 16, and a power receiving circuit 20.

The first antenna 70 and the second antenna 72 receive power supplied from a device external to the wirelessly rechargeable power supply device 10. The power received by the first antenna 70 and the second antenna 72 is input to the power receiving circuit 20. The power receiving circuit 20 includes a rectifier circuit 20a, a charging circuit 20b, a control circuit 20c, and a communication controller 20d.

The rectifier circuit 20a converts AC power received by the first antenna 70 and the second antenna 72 to DC power. The charging circuit 20b charges the power storage device 16 with the DC power output from the rectifier circuit 20a. The control circuit 20c operates the charging circuit 20b to control a charging amount of the power storage device 16.

The communication controller 20d communicates with a device external to the wirelessly rechargeable power supply device 10 via the communication antenna 14. In an example, the communication controller 20d transmits an identification signal of the wirelessly rechargeable power supply device 10 to the external device via the communication antenna 14. In an example, the communication antenna 14 is an antenna that receives microwaves in 5.7 to 5.8 GHz frequency band. Hence, the wirelessly rechargeable power supply device 10 serves as a beacon. Transmission of the identification signal allows an external power supply device to detect the presence of the wirelessly rechargeable power supply device 10. When the power supply device detects the presence of the wirelessly rechargeable power supply device 10, the power supply device wirelessly transmits power to the wirelessly rechargeable power supply device 10. The communication controller 20d may be further configured to exchange with the power supply device information related to an amount of the supply of power. The communication controller 20d uses, for example, Bluetooth Low Energy® (BLE) as a communication protocol.

The power storage device 16 is, for example, a rechargeable battery. Examples of a rechargeable battery include a lithium-ion rechargeable battery or a nickel-metal hydride rechargeable battery. The power storage device 16 is not limited to a rechargeable battery, and may be, for example, a capacitor.

### Structure of Wirelessly Rechargeable Power Supply Device

FIG. 2 shows the outer shape of the wirelessly rechargeable power supply device 10. The wirelessly rechargeable power supply device 10 is identical in shape to a dry cell battery. In particular, the wirelessly rechargeable power supply device 10 is, for example, identical in shape and dimensions to a AA dry cell battery. The wirelessly rechargeable power supply device 10 is cylindrical. The wirelessly rechargeable power supply device 10 includes a positive electrode 40 protruding on a top surface of the cylindrical shape. The wirelessly rechargeable power supply device 10 accommodates the components shown in FIG. 1 in a cavity defined by a first housing 30 and a second housing 32. Hereinafter, the first housing 30 and the second housing 32 will be collectively referred to as a housing 33. The housing 33 is cylindrical.

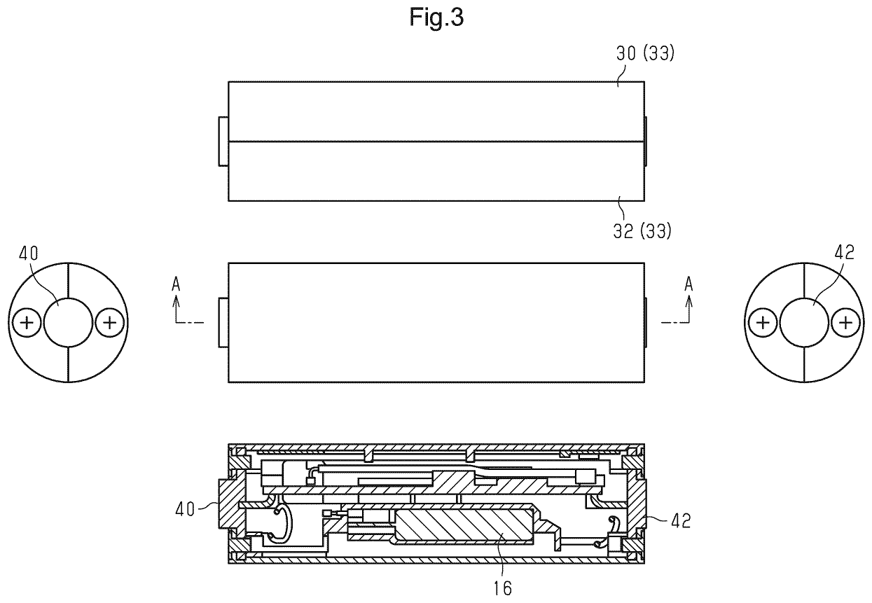

FIG. 3 shows the wirelessly rechargeable power supply device 10 as viewed from sides, top surface, and bottom surface of its cylindrical shape, as well as a cross-sectional view of the wirelessly rechargeable power supply device 10 taken along line A-A. As shown in FIG. 3, in the wirelessly rechargeable power supply device 10, the positive electrode 40 is formed on the top surface of the cylindrical shape, and the negative electrode 42 is formed on the bottom surface of the cylindrical shape.

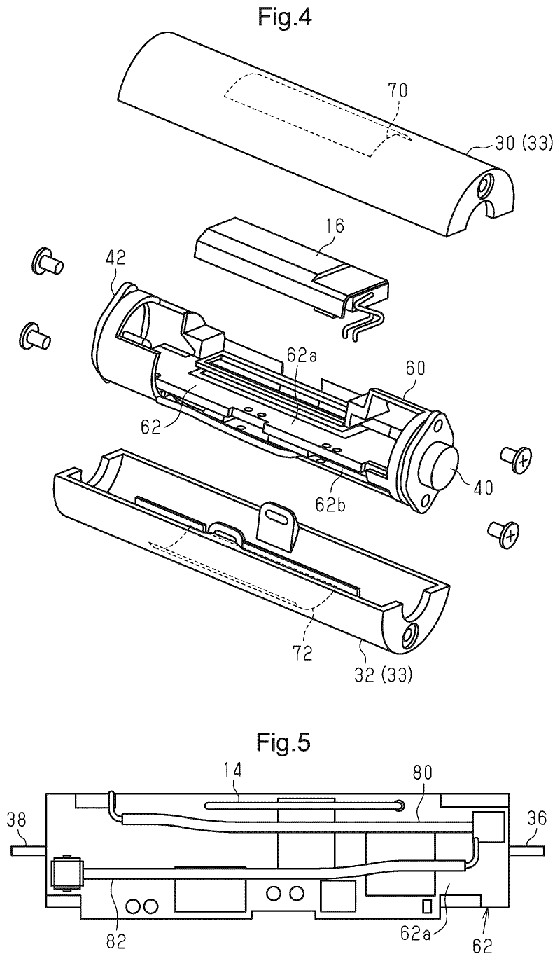

FIG. 4 is an exploded perspective view of the wirelessly rechargeable power supply device 10. As shown in FIG. 4, the wirelessly rechargeable power supply device 10 includes a chassis 60 in the cavity defined by the housing 33. A substrate 62 is fixed to the chassis 60. The substrate 62 includes a first main surface 62a and a second main surface 62b that is a surface opposite to the first main surface 62a. The substrate 62 is rectangular and has a long side extending in a longitudinal direction of the housing 33, or an axial direction of the cylindrical housing 33. The substrate 62 is arranged so that the first main surface 62a faces the first housing 30, and the second main surface 62b, which is a surface opposite to the first main surface 62a, faces the second housing 32. The power storage device 16 is arranged between the first main surface 62a of the substrate 62 and the housing 33.

FIG. 5 is a diagram of the substrate 62 as viewed from a side of the substrate 62 corresponding to the first main surface 62a. On the first main surface 62a of the substrate 62, a first coaxial cable 80 and a second coaxial cable 82 extend in the longitudinal direction of the substrate 62. The first coaxial cable 80 is connected to the first antenna 70. The second coaxial cable 82 is connected to the second antenna 72. Further, on the second main surface 62b of the substrate 62, an electrode cable 36 and an electrode cable 38 are laid out. The electrode cable 36 is connected to the positive electrode 40. The electrode cable 38 is connected to the negative electrode 42.

### Details of First Antenna and Second Antenna

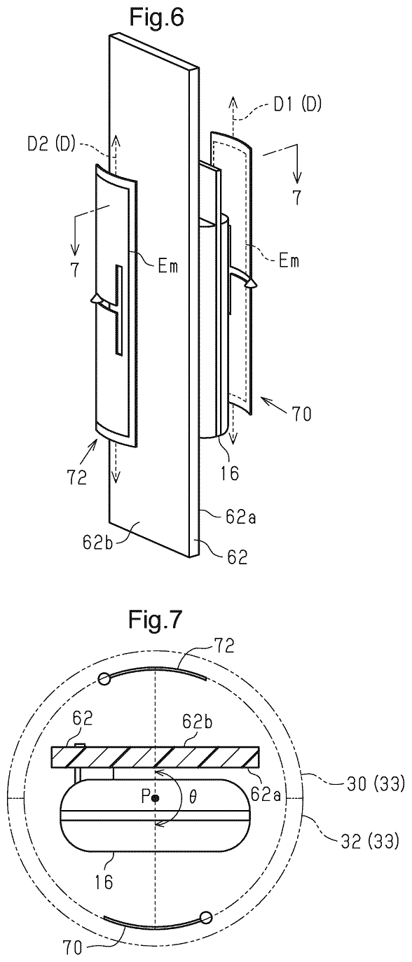

FIGS. 6 and 7 show the layout of the first antenna 70 and the second antenna 72. In FIG. 6, the longitudinal direction of the rectangular substrate 62 extends along the Z-axis. Also, the substrate 62 is parallel to a plane stretching between the Z-axis and the Y-axis. In FIG. 7, the housing 33 is indicated by imaginary lines.

Each of the first antenna 70 and the second antenna 72 is a dipole antenna. Each of the first antenna 70 and the second antenna 72 is a flexible printed circuit antenna (FPC antenna).

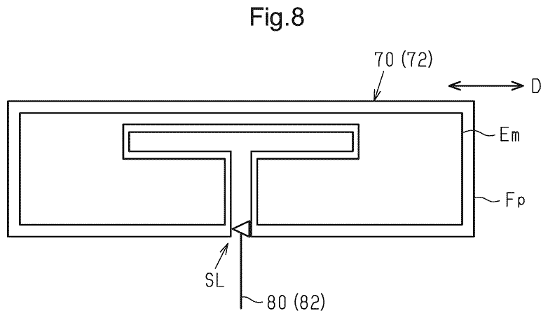

FIG. 8 shows the configuration of the first antenna 70 and the second antenna 72. Each of the first antenna 70 and the second antenna 72 includes an element Em patterned on a rectangular flexible printed circuit board Fp. The flexible printed circuit board Fp has a short side extending in a transverse direction and a long side extending in a longitudinal direction. The element Em is a conductor. In an example, the element Em is a copper foil pattern. The first antenna 70 and the second antenna 72 transmit radio waves via the elements Em. In a state placed on a flat surface, the element Em has a rectangular shape with a T-shaped cutout SL. The element Em extends in a longitudinal direction D of the flexible printed circuit board Fp.

FIGS. 6 and 7 show the shapes of the first antenna 70 and the second antenna 72 in a state in which the first antenna 70 and the second antenna 72 are accommodated in the cavity defined by the housing 33. In this state, the first antenna 70 and the second antenna 72 extend along an inner circumferential surface of the housing 33. This is because the first antenna 70 and the second antenna 72 are FPC antennas, which are flexible. The first antenna 70 and the second antenna 72 are deformable along the inner circumferential surface of the housing 33. In an example, the first housing 30 and the second housing 32 are adhered to the inner circumferential surface of the housing 33.

In the housing 33, the first antenna 70 is located at a side of the substrate 62 that corresponds to the first main surface 62a. That is, the first main surface 62a of the substrate 62 faces toward the first antenna 70. Further, the first antenna 70 is arranged so that the longitudinal direction D of the flexible printed circuit board Fp coincides with the longitudinal direction of the substrate 62 (Z-axis direction). The element Em of the first antenna 70 extends in a direction D1 that coincides with the longitudinal direction of the substrate 62 (Z-axis direction). The longitudinal direction of the substrate 62 may also be referred to as the longitudinal direction of the housing 33.

In the housing 33, the second antenna 72 is located at a side of the substrate 62 that corresponds to the second main surface 62b. That is, the second main surface 62b of the substrate 62 faces toward the second antenna 72. Further, the second antenna 72 is arranged so that the longitudinal direction D of the flexible printed circuit board Fp coincides with the longitudinal direction of the substrate 62 (Z-axis direction). The element Em of the second antenna 72 extends in a direction D2 that coincides with the longitudinal direction of the substrate 62 (Z-axis direction).

The direction D1 in which the element Em of the first antenna 70 extends coincides with the direction D2 in which the element Em of the second antenna 72 extends. A state in which the direction D1 coincides with the direction D2 includes a state in which the two directions are slightly deviated from each other within a range of 15 degrees or less, in addition to a state in which the two directions completely coincide with each other. Preferably, the direction D1 and the direction D2 completely coincide with each other.

The first antenna 70 includes the functionality of a dipole antenna that has directivity oriented toward a positive X-axis direction. The second antenna 72 includes the functionality of a dipole antenna that has directivity oriented toward a negative X-axis direction. As described above, the first antenna 70 and the second antenna 72 are both arcuate along the inner circumferential surface of the housing 33 about the axis of the housing 33. Therefore, the first antenna 70 acts as a dipole antenna that has directivity extending in the positive X-axis direction and spreading toward positive and negative sides of the Y-axis. Likewise, the second antenna 72 acts as a dipole antenna that has directivity extending in the negative X-axis direction and spreading toward positive and negative sides of the Y-axis.

The arrangement of the first antenna 70 and the second antenna 72 will now be described with respect to the longitudinal direction of the housing 33 (Z-axis direction) and a circumferential direction of the housing 33.

Preferably, the first antenna 70 is arranged at a position near the longitudinal center of the housing 33. Preferably, the first antenna 70 is, for example, arranged so that at least part of the element Em overlaps the longitudinal center of the housing 33. More preferably, the first antenna 70 is, for example, arranged so that the longitudinal center of the housing 33 overlaps the center of the first antenna 70 in the direction D1 in which the element Em extends.

Likewise, it is preferred that the second antenna 72 is arranged at a position near the longitudinal center of the housing 33. Preferably, the second antenna 72 is, for example, arranged so that at least part of the element Em overlaps the longitudinal center of the housing 33. More preferably, the second antenna 72 is, for example, arranged so that the longitudinal center of the housing 33 overlaps the center of the second antenna 72 in the direction D2 in which the element Em extends. Although the relative position of the first antenna 70 and the second antenna 72 in the longitudinal direction of the housing 33 is not particularly limited, it is preferred that the first antenna 70 and the second antenna 72 are located at the same position in the longitudinal direction of the housing 33.

Preferably, the first antenna 70 and the second antenna 72 are separated from each other in the circumferential direction of the housing 33. As shown in FIG. 7, in a side view of the wirelessly rechargeable power supply device 10 as viewed in the direction D1 in which the element Em extends, the first antenna 70 and the second antenna 72 may be separated from each other in a circumferential direction of the substrate 62 by an angle defined as angle θ. In this case, angle θ is, for example, in a range of 165 degrees to 180 degrees, inclusive. Preferably, the angle θ is in a range of 170 degrees to 180 degrees, inclusive. More preferably, the angle θ is 180 degrees. The circumferential direction of the substrate 62 in a side view of the wirelessly rechargeable power supply device 10 as viewed in the direction D1 in which the element Em of the first antenna 70 extends may also be referred to as the circumferential direction of the housing 33 about the central axis of the housing 33 that extends in the longitudinal direction (Z-axis direction).

### Operation

The wirelessly rechargeable power supply device 10 includes a pair of dipole antennas, namely, the first antenna 70 and the second antenna 72. The first antenna 70 is a dipole antenna that has directivity oriented toward a direction in which the first main surface 62a of the substrate 62 faces (positive X-axis direction). The second antenna 72 is a dipole antenna having directivity oriented toward a direction in which the second main surface 62b of the substrate 62 faces (negative X-axis direction). The direction D1 in which the element Em of the first antenna 70 extends coincides with the direction D2 in which the element Em of the second antenna 72 extends. Thus, the elements Em of the first antenna 70 and the second antenna 72 extend in the same direction D1 and D2, and the first antenna 70 and the second antenna 72 have directivity oriented toward opposite sides with respect to a thickness-wise direction of the substrate 62. In this case, the first antenna 70 and the second antenna 72 complement power reception ranges of one another where the sensitivity is relatively weak with respect to the thickness-wise direction of the substrate 62. This expands the power reception ranges in the complemented directions.

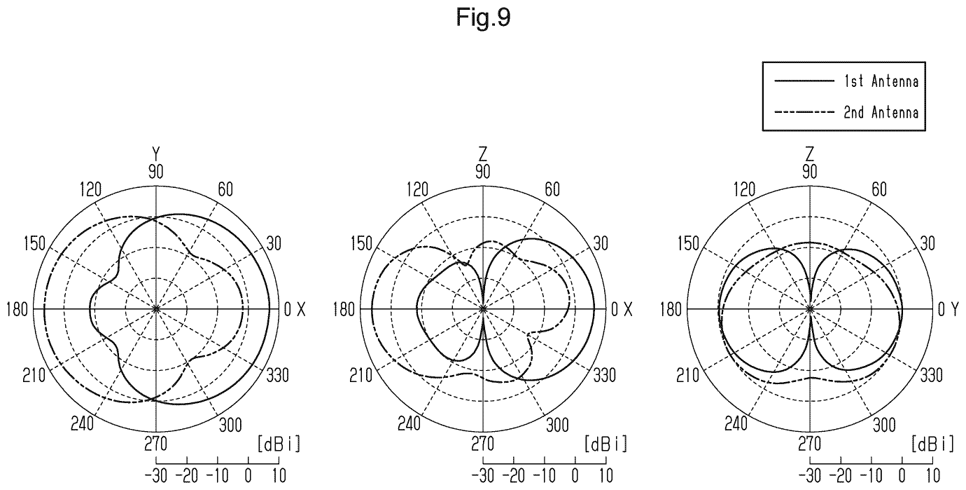

FIG. 9 shows a simulation result indicating an emission pattern of the wirelessly rechargeable power supply device 10 when the first antenna 70 and the second antenna 72 are arranged as described in the above-described embodiment. As shown in FIG. 9, the power reception range of the first antenna 70 extending in the positive X-axis direction and the power reception range of the second antenna 72 extending in the negative X-axis direction complement each other. This significantly expands the power reception ranges toward both sides of the X-axis. In a region in which the power reception ranges of the first antenna 70 and the second antenna 72 overlap each other, antenna gains are added together. Therefore, such a configuration also improves the total antenna gain.

In addition, as shown in the X-Z plan view (located in the middle) in FIG. 9 and the Y-Z plan view (located at the right side) in FIG. 9, the power reception range of the second antenna 72 also extends in the Z-axis direction. This also ensures the power reception range in the Z-axis direction. Therefore, with such a configuration, the gain in the Z-axis direction will not be zero.

### Advantages

(1) The wirelessly rechargeable power supply device 10 includes the housing 33, the substrate 62, the power storage device 16, and the power receiving antenna. The substrate 62, the power storage device 16, and the power receiving antenna are accommodated in the housing 33. The substrate 62 includes the first main surface 62a and the second main surface 62b opposite to the first main surface 62a. The power receiving circuit 20 is mounted on the substrate 62 to charge the power storage device 16 with the power received by the power receiving antenna. The power receiving antenna includes the first antenna 70 located at a side of the substrate 62 corresponding to the first main surface 62a, and the second antenna 72 located at a side of the substrate 62 corresponding to the second main surface 62b. The first antenna 70 and the second antenna 72 each include a dipole antenna. The direction D1 in which the element Em of the first antenna 70 extends coincides with the direction D2 in which the element Em of the second antenna 72 extends. This configuration expands the power reception ranges with respect to the directions in which the first main surface 62a and the second main surface 62b of the substrate 62 face (X-axis direction).

(2) In a side view of the wirelessly rechargeable power supply device 10 as viewed in the direction D1 in which the element Em of the first antenna 70 extends, the first antenna 70 and the second antenna 72 are separated from each other by approximately 180 degrees in the circumferential direction of the substrate 62. This configuration further effectively expands the power reception ranges with respect to the directions in which the first main surface 62a and the second main surface 62b of the substrate 62 face (X-axis direction).

(3) The power storage device 16 is arranged between the first main surface 62a of the substrate 62 and the first antenna 70.

With this structure, the power storage device 16 is readily accommodated in the housing 33. Accordingly, a relatively large power storage device 16 may be used together with the first antenna 70.

(4) The first antenna 70 and the second antenna 72 each include a flexible printed circuit board antenna. The first antenna 70 and the second antenna 72 are arranged along an inner circumference of the housing 33.

With this structure, the first antenna 70 and the second antenna 72, which are the FPC antenna, may be deformed along the inner circumference of the housing 33. Therefore, the first antenna 70 and the second antenna 72 may be readily accommodated in the housing 33.

(5) The wirelessly rechargeable power supply device 10 includes the first coaxial cable 80 and the second coaxial cable 82. The first antenna 70 is connected to the power receiving circuit 20 via the first coaxial cable 80. The second antenna 72 is connected to the power receiving circuit 20 via the second coaxial cable 82.

This configuration reduces a loss resulting from noise, as compared to when the first antenna 70 and the second antenna 72 are connected to the power receiving circuit 20 by a single coaxial cable.

(6) The wirelessly rechargeable power supply device 10 includes the communication antenna 14. The communication antenna 14 is configured to receive radio waves from a device external to the wirelessly rechargeable power supply device 10 and transmit radio waves to the external device. The power receiving circuit 20 is configured to control the communication with the external device.

With this configuration, the wirelessly rechargeable power supply device 10 can communicate with an external device.

(7) The wirelessly rechargeable power supply device 10 is cylindrical and includes the positive electrode 40 on the top surface and the negative electrode 42 on the bottom surface.

With this configuration, the wirelessly rechargeable power supply device 10 is identical in shape to a dry cell battery. When the dimensions of the wirelessly rechargeable power supply device 10 are set to be identical to those of a dry cell battery, the wirelessly rechargeable power supply device 10 becomes identical in shape and dimensions to a dry cell battery.

### Modified Examples

The above-described embodiment may be modified as follows. The above embodiment and the following modifications can be combined as long as the combined modifications remain technically consistent with each other.

The directions D1 and D2 in which the elements Em of the first antenna 70 and the second antenna 72 may coincide with the transverse direction of the substrate 62 (X-axis direction). Alternatively, the directions D1 and D2 in which the elements Em of the first antenna 70 and the second antenna 72 may be set independently from the direction in which the substrate 62 extends.

The first antenna and the second antenna, which are FPC antennas, do not have to be shaped as shown in FIG. 7.

As long as the first antenna 70 and the second antenna 72 are dipole antennas, the first antenna 70 and the second antenna 72 do not have to be FPC antennas. The first antenna 70 and the second antenna 72 may be different types of dipole antennas.

There may be a power receiving antenna (hereinafter, referred to as additional power receiving antenna) other than the first antenna 70 and the second antenna 72. The number of additional power receiving antennas may be one or two or more. The additional power receiving antenna may be a dipole antenna or any other conventional antenna. The layout of the additional power receiving antenna is not particularly limited, and the layout may be set in accordance with the structure of the housing 33 or the like. For example, the additional power receiving antenna may be arranged so that an element Em of the additional power receiving antenna extends in a direction orthogonal to the direction D1 in which the element Em of the first antenna 70 extends.

There may be two or more power storage devices 16. In an example in which two power storage devices 16 are included, it is preferred that one power storage device 16 is disposed between the first main surface 62a of the substrate 62 and the first antenna 70, and the other power storage device 16 is disposed between the second main surface 62b of the substrate 62 and the second antenna 72. The position of the power storage device 16 may be changed.

The communication antenna 14 is not limited to an application in which the wirelessly rechargeable power supply device 10 functions as a beacon. For example, the communication antenna 14 may be used to transmit data indicating discharge current of the wirelessly rechargeable power supply device 10 at different times of day. This allows for collection of data related to an amount of power of the wirelessly rechargeable power supply device 10 consumed by a user at different times of day.

The wirelessly rechargeable power supply device 10 does not have to include the communication antenna 14.

The first main surface 62a and the second main surface 62b of the substrate 62 do not have to be rectangular. For example, when the wirelessly rechargeable power supply device 10 does not have a shape of a dry cell battery, as described later, the housing 33 may have a shape in which a longitudinal direction cannot be specified. In this case, the substrate 62 may have a shape in which a longitudinal direction cannot be specified, such as square.

The antennas do not have to be connected to the rectifier circuit 20a by different coaxial cables.

The wirelessly rechargeable power supply device 10 does not have to be identical in shape and dimensions to a AA dry cell battery. The wirelessly rechargeable power supply device 10 may be identical in shape and dimensions to, for example, a D dry cell battery. The wirelessly rechargeable power supply device 10 may be identical in shape and dimensions to, for example, a C dry cell battery. The wirelessly rechargeable power supply device 10 may be identical in shape and dimensions to, for example, a AAA dry cell battery.

The wirelessly rechargeable power supply device 10 does not have to be cylindrical. For example, the wirelessly rechargeable power supply device 10 may be a box-shaped device, such as a 9 V dry cell battery.

The wirelessly rechargeable power supply device 10 does not have to be identical in shape and dimensions to a dry cell battery.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A wirelessly rechargeable power supply device, comprising:
a housing;
a substrate;
a power storage device; and
a power receiving antenna, wherein:
the substrate, the power storage device, and the power receiving antenna are accommodated in the housing,
the substrate includes a first main surface and a second main surface opposite to the first main surface,
a power receiving circuit configured to charge the power storage device with power received by the power receiving antenna is mounted on the substrate,
the power receiving antenna includes a first antenna located at a side of the substrate corresponding to the first main surface, and a second antenna located at a side of the substrate corresponding to the second main surface,
the first antenna and the second antenna each include a dipole antenna, and
a direction in which an element of the first antenna extends coincides with a direction in which an element of the second antenna extends.

2. The wirelessly rechargeable power supply device according to claim 1, wherein, in a side view of the wirelessly rechargeable power supply device as viewed in the direction in which the element of the first antenna extends, the first antenna and the second antenna are separated from each other in a circumferential direction of the substrate by an angle in a range of 165 degrees to 180 degrees, inclusive.

3. The wirelessly rechargeable power supply device according to claim 1, wherein the power storage device is arranged between the first main surface of the substrate and the first antenna.

4. The wirelessly rechargeable power supply device according to claim 1, wherein
the first antenna and the second antenna each include a flexible printed circuit board antenna, and
the first antenna and the second antenna are arranged along an inner circumference of the housing.

5. The wirelessly rechargeable power supply device according to claim 1, wherein
the substrate is rectangular and has a long side extending in a longitudinal direction and a short side extending in a transverse direction, and
the direction in which the element of the first antenna extends and the direction in which the element of the second antenna extends coincide with the longitudinal direction.

6. The wirelessly rechargeable power supply device according to claim 1, further comprising:
a first coaxial cable and a second coaxial cable, wherein
the first antenna is connected to the power receiving circuit via the first coaxial cable, and
the second antenna is connected to the power receiving circuit via the second coaxial cable.

7. The wirelessly rechargeable power supply device according to claim 1, further comprising:
a communication antenna, wherein
the communication antenna is configured to receive radio waves from a device external to the wirelessly rechargeable power supply device, and transmit radio waves to the device external to the wirelessly rechargeable power supply device, and
the power receiving circuit is configured to control communication with the device external to the wirelessly rechargeable power supply device.

8. The wirelessly rechargeable power supply device according to claim 1, wherein the wirelessly rechargeable power supply device is cylindrical and includes a positive electrode on a top surface and a negative electrode on a bottom surface.
